(19) United States
(12) Patent Application Publication
(10) Pub. No.: US 2020/0255023 A1
(43) Pub. Date: Aug. 13, 2020

(54) VEHICLE CONTROL DEVICE, VEHICLE, AND VEHICLE CONTROL METHOD

(71) Applicant: HONDA MOTOR CO., LTD., Tokyo (JP)

(72) Inventors: Tadahiko KANOH, Wako-Shi (JP); Kanta TSUJI, Wako-Shi (JP); Daichi KATO, Wako-Shi (JP)

(21) Appl. No.: 16/785,078

(22) Filed: Feb. 7, 2020

(30) Foreign Application Priority Data
Feb. 8, 2019 (JP) 2019-021731

(51) Int. Cl. B60W 50/12; B60W 30/12

(52) U.S. Cl. CPC B60W 50/12; B60W 30/12

(57) ABSTRACT

A vehicle control device includes a restricted area determination unit that determines whether or not, in a portion in front of a host vehicle within another lane, a predetermined restricted area exists in which continuous traveling of the host vehicle in the other lane is restricted, and a control unit that restricts a lane change of the host vehicle into the other lane in the case that the restricted area determination unit determines that the predetermined restricted area exists in the other lane.

### CROSS-REFERENCE TO RELATED APPLICATION

This application is based upon and claims the benefit of priority from Japanese Patent Application No. 2019-021731 filed on Feb. 8, 2019, the contents of which are incorporated herein by reference.

### BACKGROUND OF THE INVENTION

### Field of the Invention

The present invention relates to a vehicle control device, a vehicle, and a vehicle control method.

### Description of the Related Art

In Japanese Patent No. 6209232, it is disclosed that, corresponding to a type of lane marking, a determination is made as to whether or not a lane change can be carried out.

### SUMMARY OF THE INVENTION

However, with the technique disclosed in Japanese Patent No. 6209232, it is not always possible to suitably limit or restrict the lane change.

An object of the present invention is to provide a vehicle control device, a vehicle, and a vehicle control method in which a lane change can be suitably restricted.

A vehicle control device according to one aspect of the present invention comprises a restricted area determination unit configured to determine whether or not, in a portion in front of a host vehicle within another lane that differs from a host vehicle lane in which the host vehicle is traveling, a predetermined restricted area exists in which continuous traveling of the host vehicle in the other lane is restricted, and a control unit configured to restrict a lane change of the host vehicle into the other lane in a case that the restricted area determination unit determines that the predetermined restricted area exists in the other lane.

A vehicle according to another aspect of the present invention comprises the vehicle control device as described above.

A vehicle control method according to another aspect of the present invention comprises a step of determining whether or not, in a portion in front of a host vehicle within another lane that differs from a host vehicle lane in which the host vehicle is traveling, a predetermined restricted area exists in which continuous traveling of the host vehicle in the other lane is restricted, and a step of restricting a lane change of the host vehicle into the other lane in a case it is determined that the predetermined restricted area exists in the other lane, in the step of determining whether or not the predetermined restricted area exists.

According to the present invention, it is possible to provide a vehicle control device, a vehicle, and a vehicle control method in which a lane change can be suitably restricted.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a vehicle according to an embodiment of the present invention;

FIGS. 2A, 2B, 2C and 2D are diagrams showing examples of road signs and road markings;

FIG. 3 is a view showing an example of a travel lane;

FIG. 4A and FIG. 4B are diagrams showing examples of travel lanes;

FIG. 5 is a view showing an example of a travel lane;

FIG. 6 is a flowchart showing an example of operations of the vehicle control device according to the embodiment;

FIG. 7 is a flowchart illustrating an example of operations of the vehicle control device according to the embodiment;

FIG. 8 is a flowchart illustrating an example of operations of the vehicle control device according to the embodiment; and

FIG. 9 is a flowchart illustrating an example of operations of the vehicle control device according to the embodiment.

### DESCRIPTION OF THE PREFERRED EMBODIMENTS

Preferred embodiments of a vehicle control device, a vehicle, and a vehicle control method according to the present invention will be presented and described in detail below with reference to the accompanying drawings.

### EMBODIMENT

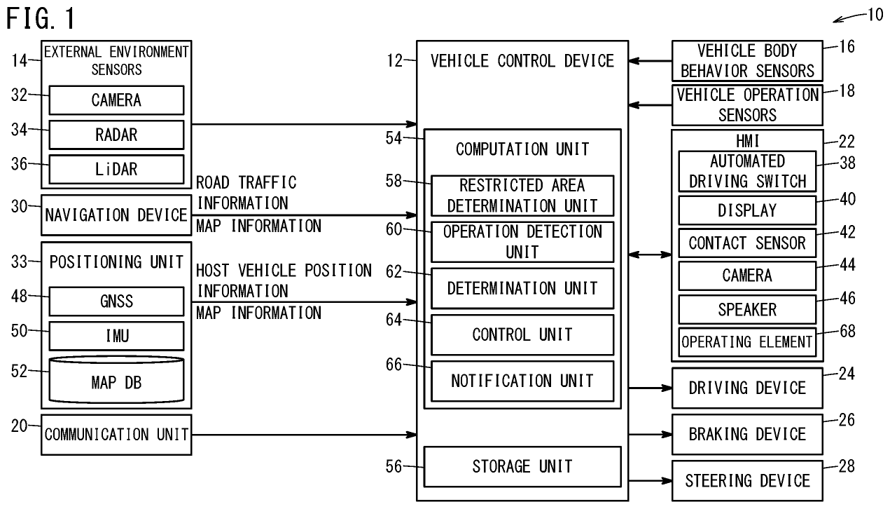

A vehicle control device, a vehicle, and a vehicle control method according to embodiments of the present invention will be described with reference to the drawings. FIG. 1 is a block diagram showing a vehicle according to the present embodiment.

A vehicle (host vehicle) 10 is equipped with a vehicle control device 12, namely, a vehicle control ECU (Electronic Control Unit). The vehicle 10 is further equipped with external environment sensors 14, vehicle body behavior sensors 16, vehicle operation sensors 18, a communication unit 20, and an HMI (Human Machine Interface) 22. The vehicle 10 is further equipped with a driving device 24, a braking device 26, a steering device 28, a navigation device 30, and a positioning unit 33. Although the vehicle 10 is equipped with other constituent elements apart from those noted above, description of such elements is omitted herein.

The external environment sensors 14 acquire external environmental information, that is, peripheral information around the vicinity of the vehicle 10. The external environment sensors 14 include a plurality of cameras 32 and a plurality of radar devices 34. Among the external environment sensors 14, there are further included a plurality of LiDAR (Light Detection And Ranging, Laser Imaging Detection and Ranging) devices 36.

Information acquired by cameras (imaging units) 32, i.e., camera information, is supplied from the cameras 32 to the vehicle control device 12. As such camera information, there may be cited captured image information and the like. The camera information, together with radar information and LiDAR information to be described later, makes up the external environmental information. Although a single camera 32 is illustrated in FIG. 1, a plurality of cameras 32 are actually provided.

The radar devices 34 emit transmitted waves toward the exterior of the vehicle 10, and receive reflected waves that are reflected and returned by detected objects. As examples of the transmitted waves, there may be cited electromagnetic waves. As examples of the electromagnetic waves, there may be cited millimeter waves. As examples of the detected objects, there may be cited other vehicles (not shown) including a preceding vehicle (not shown). The radar devices 34 generate radar information (reflected wave signals) based on the reflected waves or the like. The radar devices 34 supply the generated radar information to the vehicle control device 12. Although one radar device 34 is illustrated in FIG. 1, a plurality of radar devices 34 are actually provided in the vehicle 10. Moreover, the radar devices 34 are not limited to using millimeter wave radar. For example, laser radar devices, or ultrasonic sensors or the like may be used as the radar devices 34.

The LiDAR devices 36 continuously irradiate lasers in all directions of the vehicle 10, measure the three dimensional positions of reflection points based on reflected waves of the emitted lasers, and output information, i.e., three dimensional information, in relation to the three dimensional positions. The LiDAR devices 36 supply the three dimensional information, i.e., LiDAR information, to the vehicle control device 12. Although one LiDAR device 36 is illustrated in FIG. 1, a plurality of LiDAR devices 36 are actually provided in the vehicle 10.

The vehicle body behavior sensors 16 acquire information, namely, vehicle body behavior information, in relation to the behavior of the vehicle 10. The vehicle body behavior sensors 16 include a non-illustrated vehicle speed sensor, non-illustrated vehicle wheel speed sensors, a non-illustrated acceleration sensor, and a non-illustrated yaw rate sensor. The vehicle speed sensor detects the speed, i.e., the vehicle speed, of the vehicle 10. Further, the vehicle speed sensor detects the direction in which the vehicle 10 is traveling. The vehicle wheel speed sensors detect the speed, i.e., the vehicle wheel speed, of non-illustrated vehicle wheels. The acceleration sensor detects the acceleration of the vehicle 10. The term “acceleration” includes a longitudinal acceleration, a lateral acceleration, and a vertical acceleration. It should be noted that the acceleration of only a portion of the aforementioned directions may be detected by the acceleration sensor. The yaw rate sensor detects a yaw rate of the vehicle 10.

The vehicle operation sensors (driving operation sensors) 18 acquire information, namely, driving operation information, in relation to driving operations made by a user (driver). The vehicle operation sensors 18 include a non-illustrated accelerator pedal sensor, a non-illustrated brake pedal sensor, a non-illustrated steering angle sensor, and a non-illustrated steering torque sensor. The accelerator pedal sensor detects an operated amount of a non-illustrated accelerator pedal. The brake pedal sensor detects an operated amount of a non-illustrated brake pedal. The steering angle sensor detects the steering angle of a non-illustrated steering wheel. The torque sensor detects a torque applied to the steering wheel.

The communication unit 20 performs wireless communications with non-illustrated external equipment. The external equipment may include, for example, a non-illustrated external server. The communication unit 20 may be capable of being detached from the vehicle 10, or may be non-detachable with respect to the vehicle. As examples of the communication unit 20 that can be attached to and detached from the vehicle 10, there may be cited a mobile phone and a smartphone.

The HMI 22 receives an operation input made by the user (vehicle occupant), and provides various types of information to the user in a visual, audible, or tactile manner. The HMI 22 includes, for example, an automated driving switch (driving assist switch) 38, a display 40, a contact sensor 42, a camera 44, a speaker 46, and an operating element 68.

The automated driving switch 38 is used by the user in order to instruct starting or stopping of automated driving. The automated driving switch 38 includes a non-illustrated start switch and a non-illustrated stop switch. The start switch outputs a start signal to the vehicle control device 12 in accordance with an operation of the user. The stop switch outputs a stop signal to the vehicle control device 12 in accordance with an operation of the user.

The display (display unit) 40 includes, for example, a liquid crystal panel or an organic EL panel or the like. In this instance, although an exemplary case will be described in which the display 40 is a touch panel, the present invention is not limited to this feature.

The contact sensor 42 serves to detect whether or not the user (driver) is touching the steering wheel. Signals output from the contact sensor 42 are supplied to the vehicle control device 12. On the basis of input signals supplied from the contact sensor 42, the vehicle control device 12 is capable of determining whether or not the user is touching the steering wheel.

The camera 44 captures images of the interior, i.e., a non-illustrated vehicle compartment interior, of the vehicle 10. The camera 44 may be disposed, for example, on a non-illustrated dashboard, or may be disposed on a non-illustrated ceiling of the vehicle. Further, the camera 44 may be disposed in a manner so that images are captured of only the driver, or may be disposed in a manner so that images are captured of each of the vehicle occupants. The camera 44 outputs information, i.e., image information, which is acquired by capturing images of the vehicle compartment interior, to the vehicle control device 12.

The speaker 46 serves to provide various types of information to the user by way of sound or voice. The vehicle control device 12 outputs various notifications, alarms, or the like using the speaker 46.

The operating element (operation input unit) 68 is an element by which the user performs an operation input in order to instruct a lane change. The operating element 68, for example, is a non-illustrated lever-shaped operating element; however, the present invention is not limited to this feature. The operating element 68 is provided, for example, on a non-illustrated steering column; however, the present invention is not limited to this feature. The operating element 68 can be turned clockwise and counterclockwise about a support shaft. The operating element 68 is equipped with a non-illustrated operation position sensor. The operation position sensor detects operated positions of the operating element 68. The operating element 68 supplies information obtained by the operation position sensor, namely, information concerning the operated position of the operating element 68, to an operation detection unit 60, to be described later.

The driving device (driving force control system) 24 includes a non-illustrated drive ECU, and a non-illustrated drive source. By controlling the drive source, the drive ECU controls the driving force (torque) of the vehicle 10. As examples of the drive source, there may be cited an engine or a drive motor. The drive ECU is capable of controlling the driving force by controlling the drive source, based on an operation made by the user on the accelerator pedal. Further, the drive ECU is capable of controlling the driving force by controlling the drive source, based on a command supplied from the vehicle control device 12. The driving force of the drive source is transmitted to the non-illustrated vehicle wheels via a non-illustrated transmission.

The braking device (braking force control system) 26 includes a non-illustrated brake ECU, and a non-illustrated brake mechanism. The brake mechanism actuates a brake member by a brake motor, a hydraulic mechanism, or the like. The brake ECU is capable of controlling the braking force by controlling the drive mechanism, based on an operation made by the user on the brake pedal. Further, the brake ECU is capable of controlling the braking force by controlling the brake mechanism, based on a command supplied from the vehicle control device 12.

The steering device (steering system) 28 includes a non-illustrated steering ECU, and more specifically, an EPS (electric power steering system) ECU, and a non-illustrated steering motor. The steering ECU controls the direction of the vehicle wheels (steering wheels) by controlling the steering motor, based on an operation made by the user on the steering wheel. Further, the steering ECU controls the direction of the vehicle wheels by controlling the steering motor, based on a command supplied from the vehicle control device 12. Steering may be performed by changing the torque distribution and the braking force distribution to the left and right vehicle wheels.

The navigation device 30 is equipped with a non-illustrated GNSS (Global Navigation Satellite System) sensor. In addition, the navigation device 30 is further equipped with a non-illustrated computation unit and a non-illustrated storage unit. The GNSS sensor detects the current position of the vehicle 10. From a non-illustrated map database stored in the storage unit, the computation unit reads out map information corresponding to the current position detected by the GNSS sensor. Using the map information, the computation unit determines a target route from the current position to a destination. The destination is input by the user via the HMI 22. As noted previously, the display 40 is a touch panel. The destination is input by the touch panel being operated by the user. The navigation device 30 outputs the created target route to the vehicle control device 12. The vehicle control device 12 supplies the target route to the HMI 22. The HMI 22 displays the target route on the display 40. The navigation device 30 is capable of supplying map information to the vehicle control device 12. Further, the navigation device 30 is capable of acquiring road traffic information. Such road traffic information can be supplied to the navigation device 30, for example, by an FM multiplex broadcast, beacons, or the like. Further, the navigation device 30 is capable of supplying the road traffic information to the vehicle control device 12.

The positioning unit 33 is equipped with a GNSS 48. The positioning unit 33 is further provided with an IMU (Inertial Measurement Unit) 50 and a map database (map DB) 52. The positioning unit 33 specifies the position of the vehicle 10 by appropriately using the information obtained by the GNSS 48, the information obtained by the IMU 50, and the map information stored in the map database 52. The positioning unit 33 is capable of supplying host vehicle position information, which is information indicative of the position of the host vehicle 10, to the vehicle control device 12. Further, the positioning unit 33 is capable of supplying the map information to the vehicle control device 12.

The vehicle control device 12 is equipped with a computation unit 54 and a storage unit 56. The computation unit 54 governs the overall control of the vehicle control device 12. The computation unit 54 is constituted, for example, by a CPU (Central Processing Unit). The computation unit 54 executes the vehicle control by controlling each of the respective units based on programs stored in the storage unit 56.

The computation unit 54 is equipped with a restricted area determination unit 58, an operation detection unit 60, a determination unit 62, a control unit 64, and a notification unit 66. The restricted area determination unit 58, the operation detection unit 60, the determination unit 62, the control unit 64, and the notification unit 66 can be realized by the computation unit 54 executing programs which are stored in the storage unit 56.

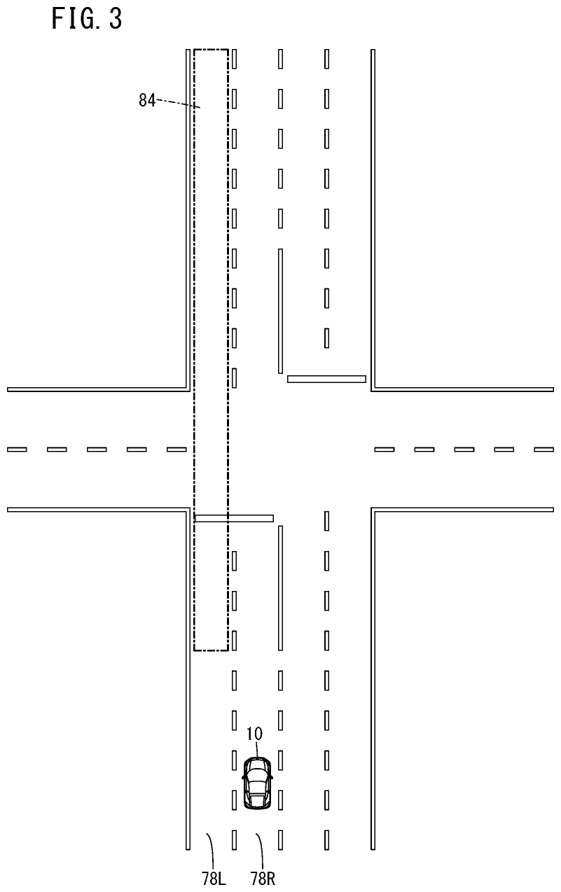

The restricted area determination unit 58 determines whether or not a predetermined restricted area 84 exists in a portion (range) in front of the host vehicle 10 within a lane (other lane) 78 that differs from the lane (host vehicle lane) 78 in which the host vehicle 10 is traveling (see FIGS. 3 to 5). The predetermined restricted area 84 is an area in which continuous traveling of the host vehicle 10 in the other lane 78 is restricted. The predetermined restricted area 84 is a defined area. A case in which continuous traveling of the host vehicle 10 in the other lane 78 is restricted due to the presence of a non-illustrated fallen object in the other lane 78 does not correspond to a case in which the predetermined restricted area 84 exists. A case in which continuous traveling of the host vehicle 10 in the other lane 78 is restricted due to the presence of a non-illustrated other vehicle in the other lane 78 also does not correspond to a case in which the predetermined restricted area 84 exists. The lane change is carried out in the case that such a fallen object or the like does not exist in the lane 78 into which the lane change is to be made. The vehicle control device 12 according to the present embodiment restricts the lane change in the case that the predetermined restricted area 84 exists in the other lane 78, regardless of whether a fallen object or the like does not exist in the other lane 78 into which the lane changed is to be made. Moreover, the portion in front of the host vehicle 10 is a range, within the area in front of the host vehicle 10, in which the distance from the host vehicle 10 is less than or equal to the predetermined distance, or a range that the host vehicle 10 is capable of reaching within a predetermined time period. It should be noted that, when describing the lanes in general, the reference numeral 78 is used, and when describing individual lanes, the reference numerals 78L and 78R are used. In the case that the restricted area determination unit 58 has determined that the predetermined restricted area 84 exists in the portion in front of the host vehicle 10 within the other lane 78, the control unit 64 restricts the lane change of the host vehicle 10 into the other lane 78. Moreover, in the case that the lane 78 into which the lane change is to be made is a lane 78 that leads to the destination, even in the case it is determined by the restricted area determination unit 58 that the predetermined restricted area 84 exists in the other lane 78, the control unit 64 does not restrict the lane change.

As examples of the predetermined restricted area 84, there may be cited a dedicated passing lane, a priority passing lane, or the like. The dedicated passing lane is a lane through which a specified type of vehicle passes. The priority passing lane is a lane in which passing of a specified type of vehicle is given priority. Road signs, road markings, or the like are arranged in the dedicated passing lane, the priority passing lane, or the like.

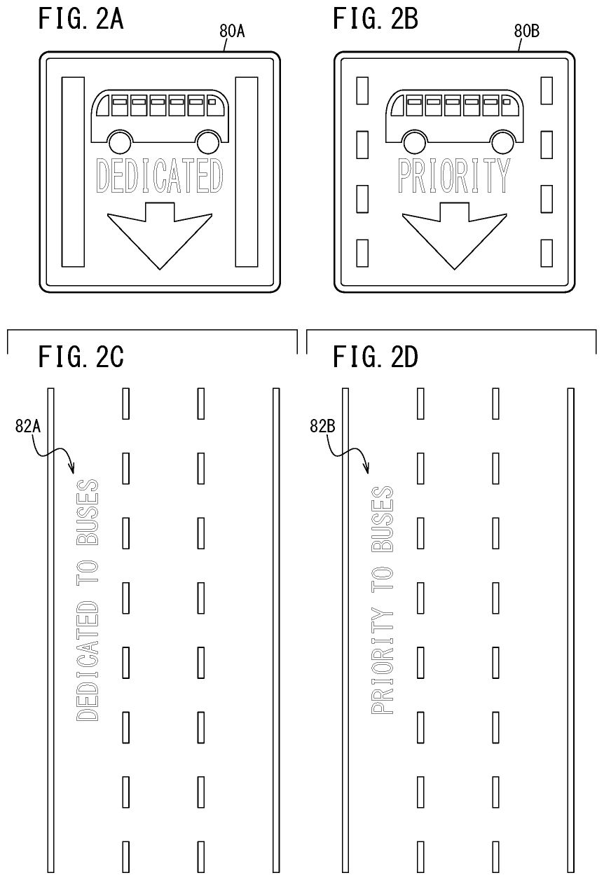

FIG. 2A is a diagram illustrating an example of a road sign of the dedicated passing lane. The road sign 80A shown in FIG. 2A can be arranged, for example, in proximity to a starting point of the dedicated passing lane. The road sign 80A indicates that the passing lane is a dedicated passing lane through which a fixed route bus passes. In this instance, although an exemplary case of a dedicated passing lane for a fixed route bus has been described, the present invention is not limited to this feature. As examples of a dedicated passing lane other than a dedicated passing lane for a fixed route bus, there may be cited a dedicated passing lane for bicycles, and a dedicated passing lane for motorcycles or the like. However, the present invention is not limited to such examples. Moreover, a time zone within which such a passing lane serves as a dedicated passing lane may be written on the road sign 80A.

FIG. 2B is a diagram illustrating an example of a road sign of the priority passing lane. The road sign 80B shown in FIG. 2B can be arranged, for example, in proximity to a starting point of the priority passing lane. The road sign 80B indicates that the passing lane is a priority passing lane through which passing of a fixed route bus is given priority. In this instance, although an exemplary case of a priority passing lane for a fixed route bus has been described, the present invention is not limited to this feature. As examples of a priority passing lane other than a priority passing lane for a fixed route bus, there may be cited a priority passing lane for bicycles, and a priority passing lane for motorcycles or the like. However, the present invention is not limited to such examples. Moreover, a time zone within which such a passing lane serves as a priority passing lane may be written on the road sign 80B.

FIG. 2C is a diagram illustrating an example of a road marking for the dedicated passing lane. The road marking 82A shown in FIG. 2C is written, for example, on the road surface in the dedicated passing lane. The road marking 82A indicates that the passing lane is a dedicated passing lane through which a fixed route bus passes. Moreover, a time zone within which such a passing lane serves as a dedicated passing lane may be written on the road surface.

FIG. 2D is a diagram illustrating an example of a road marking for the priority passing lane. The road marking 82B shown in FIG. 2D is written, for example, on the road surface in the priority passing lane. The road marking 82B indicates that the passing lane is a priority passing lane through which passing of a fixed route bus is given priority. Moreover, a time zone within which such a passing lane serves as a priority passing lane may be written on the road surface.

It should be noted that the reference numeral 80 is used when descriptions are given concerning road signs in general, whereas the reference numerals 80A and 80B are used when descriptions are given concerning individual road signs. Further, it should be noted that the reference numeral 82 is used when descriptions are given concerning road markings in general, whereas the reference numerals 82A and 82B are used when descriptions are given concerning individual road markings.

The restricted area determination unit 58 is capable of determining whether or not the predetermined restricted area 84 exists in a portion in front of the host vehicle 10 within the other lane 78, on the basis of, for example, the road signs 80, the road markings 82, or the like. Moreover, the road signs 80, the road markings 82, or the like can be detected by the external environment sensors 14 or the like. In such a manner, the restricted area determination unit 58 is capable of determining whether or not the predetermined restricted area 84 exists in the portion in front of the host vehicle 10 within the other lane 78, on the basis of information or the like acquired by the external environment sensors 14. Moreover, as noted previously, a time zone within which such a passing lane serves as a dedicated passing lane or a priority passing lane may be written on the road signs 80 or the road surface. In such a case, based on the time zone written on the road signs 80 or the road surface and the current time, the restricted area determination unit 58 determines whether or not the passing lane is a dedicated passing lane or a priority passing lane.

Moreover, in this instance, although an exemplary case has been described in which the determination of whether or not the predetermined restricted area 84 exists in the portion in front of the host vehicle 10 within the other lane 78 is made on the basis of information or the like acquired by the external environment sensors 14, the present invention is not limited to this feature. Whether or not the predetermined restricted area 84 exists in the portion in front of the host vehicle 10 within the other lane 78 may also be determined on the basis of the host vehicle position information and the map information.

In the case that the dedicated passing lane through which a specified type of vehicle passes exists in the portion in front of the host vehicle 10 within the other lane 78, and the host vehicle 10 does not correspond to the specified type of vehicle, the restricted area determination unit 58 makes a determination in the following manner. More specifically, in such a case, the restricted area determination unit 58 determines that the predetermined restricted area 84 exists in the portion in front of the host vehicle 10 within the other lane 78.

In the case that the priority passing lane in which passing of a specified type of vehicle is given priority exists in the portion in front of the host vehicle 10 within the other lane 78, and the host vehicle 10 does not correspond to the specified type of vehicle, the restricted area determination unit 58 makes a determination in the following manner. More specifically, in such a case, the restricted area determination unit 58 determines that the predetermined restricted area 84 exists in the portion in front of the host vehicle 10 within the other lane 78.

The determination unit 62 determines whether or not a distance to the predetermined restricted area 84, or a time period until the host vehicle 10 reaches the predetermined restricted area 84 is greater than or equal to a threshold value. In the case it is determined by the determination unit 62 that the distance to the predetermined restricted area 84, or the time period until the host vehicle 10 reaches the predetermined restricted area 84 is greater than or equal to the threshold value, the control unit 64 permits the lane change of the host vehicle 10 into the other lane 78. More specifically, in the case that the distance to the predetermined restricted area 84 is sufficiently large, or in the case that the time period until the host vehicle 10 reaches the predetermined restricted area 84 is sufficiently long, the control unit 64 permits the lane change of the host vehicle 10 into the other lane 78. In the case it is determined by the determination unit 62 that the distance to the predetermined restricted area 84, or the time period until the host vehicle 10 reaches the predetermined restricted area 84 is less than the threshold value, the control unit 64 restricts the lane change of the host vehicle 10 into the other lane 78. More specifically, in the case that the distance to the predetermined restricted area 84 is not sufficiently large, or in the case that the time period until the host vehicle 10 reaches the predetermined restricted area 84 is not sufficiently long, the control unit 64 restricts the lane change of the host vehicle 10 into the other lane 78.

In the case that a state has come about in which the predetermined restricted area 84 does not exist in the portion in front of the host vehicle 10 within the other lane 78 after the lane change of the host vehicle 10 into the other lane 78 is restricted, the notification unit 66 (notification control unit) issues a predetermined notification to the user. The predetermined notification is a notification for indicating that the restriction on the lane change has been released. The notification unit 66 issues the predetermined notification to the user using the HMI 22, for example. More specifically, the notification unit 66 issues the predetermined notification to the user by way of voice. Such a voice message can be output, for example, using the speaker 46.

Moreover, in this instance, although an exemplary case has been described in which the predetermined notification is issued by way of voice, the present invention is not limited to this feature. For example, the predetermined notification may be issued by way of a display. Further, the predetermined notification may be issued by way of a combination of voice and display. The predetermined notification by way of a display can be issued, for example, using the display 40 or the like.

FIG. 3 is a view showing an example of a travel lane. The lane 78L is a left side lane, and the lane 78R is a right side lane. In FIG. 3, an example is shown of a case in which the host vehicle 10 is traveling in the right side lane 78R. In FIG. 3, an example is shown of a case in which the predetermined restricted area 84 exists in the portion in front of the host vehicle 10 within the lane 78L.

On the basis of signals supplied from the operating element 68, the operation detection unit 60 detects operation inputs performed by the user to the operating element 68. The control unit 64 is capable of performing a lane change control on the basis of an operation input detected by the operation detection unit 60. For example, in the case that an operation input to turn the operating element 68 counterclockwise is made when the host vehicle 10 is traveling in the lane 78R, the lane change corresponding to the operation input is a lane change into the lane 78L (other lane). In the example illustrated in FIG. 3, since it is determined by the restricted area determination unit 58 that the predetermined restricted area 84 exists in the portion in front of the host vehicle 10 within the other lane 78L, the control unit 64 restricts such a lane change.

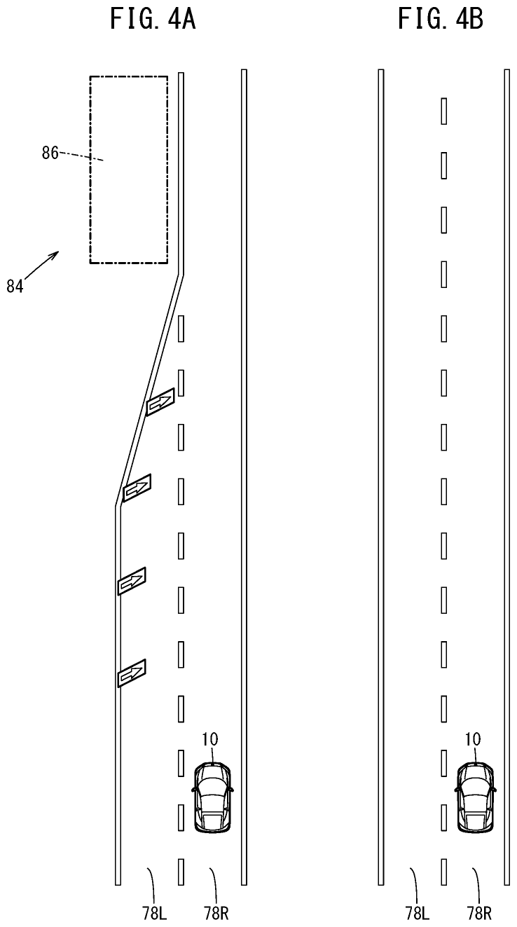

FIG. 4A and FIG. 4B are diagrams showing examples of travel lanes. In FIGS. 4A and 4B, examples are shown of cases in which the host vehicle 10 is traveling in the right side lane 78R. In FIG. 4A, an example is shown of a case in which the predetermined restricted area 84 exists in the portion in front of the host vehicle 10 within the lane 78L. More specifically, in FIG. 4A, an example is shown in which the predetermined restricted area 84 is constituted by a construction site 86. In FIG. 4B, an example of the map information is shown. In the example shown in FIG. 4B, a state of construction is not reflected in the map information.

For example, in the case that an operation input to turn the operating element 68 counterclockwise is made when the host vehicle 10 is traveling in the lane 78R, the lane change corresponding to the operation input is a lane change into the lane 78L (other lane). In the map information, the predetermined restricted area 84 does not exist in the portion in front of the host vehicle 10 within the other lane 78L. However, in the information acquired by the external environment sensors 14, the predetermined restricted area 84 exists in the portion in front of the host vehicle 10 within the other lane 78L. In such a case, the restricted area determination unit 58 determines that the predetermined restricted area 84 exists on the basis of the information acquired by the external environment sensors 14. In the example illustrated in FIG. 4A, since it is determined by the restricted area determination unit 58 that the predetermined restricted area 84 exists in the portion in front of the host vehicle 10 within the other lane 78L, the control unit 64 restricts such a lane change.

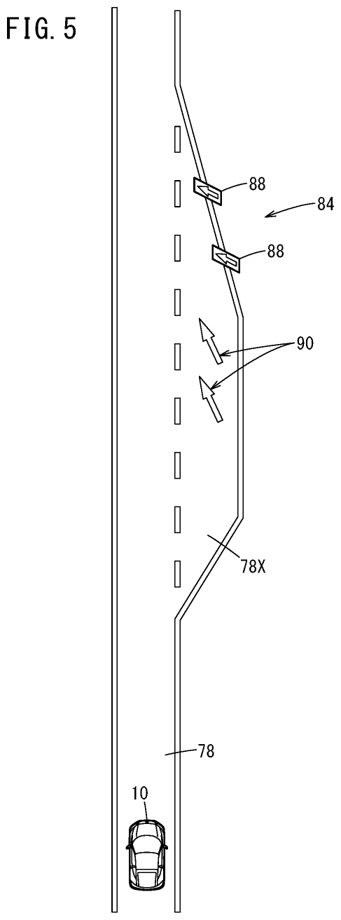

FIG. 5 is a view showing an example of a travel lane. In FIG. 5, an example is shown of a case in which an overtaking lane (lane) 78X exists on the right side of the lane 78 in which the host vehicle 10 is traveling. In the vicinity of an end point of the overtaking lane 78X, road signs 88 of arrows and road markings 90 of arrows are arranged for prompting a lane change into the lane 78. Tentatively, in the case that the host vehicle 10 makes a lane change from the lane 78 into the overtaking lane 78X, it becomes necessary for the host vehicle 10 to make a lane change from the overtaking lane 78X into the lane 78. That is, such an overtaking lane 78X can be considered as corresponding to the predetermined restricted area 84.

For example, in the case that an operation input to turn the operating element 68 clockwise is made when the host vehicle 10 is traveling in the lane 78, the lane change corresponding to the operation input is a lane change into the lane (other lane) 78X. In the example illustrated in FIG. 5, since it is determined by the restricted area determination unit 58 that the predetermined restricted area 84 exists in the portion in front of the host vehicle 10 within the other lane 78X, the control unit 64 restricts such a lane change.

The storage unit 56 includes a non-illustrated volatile memory, and a non-illustrated nonvolatile memory. As an example of the volatile memory, there may be cited a RAM (Random Access Memory). As an example of the nonvolatile memory, there may be cited a ROM (Read Only Memory), a flash memory, or the like. The external environmental information, the vehicle body behavior information, and the vehicle operation information, etc., are stored, for example, in the volatile memory. Programs, tables, maps, and the like are stored, for example, in the nonvolatile memory.

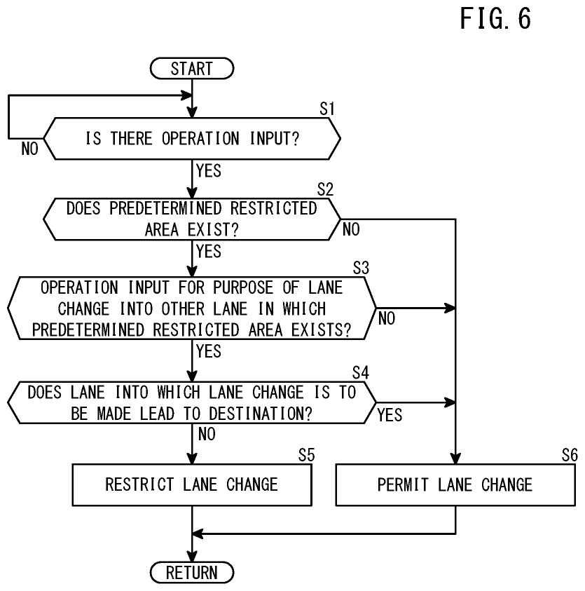

FIG. 6 is a flowchart showing an example of operations of the vehicle control device according to the present embodiment.

In step S1, on the basis of a signal supplied from the operating element 68, the operation detection unit 60 detects whether or not an operation input to the operating element 68 has been performed by the user. The operation input to the operating element 68, as noted previously, is an operation input made by the user to instruct a lane change. If such an operation input to the operating element 68 has been performed (YES in step S1), the process transitions to step S2. If such an operation input to the operating element 68 has not been performed (NO in step S1), then step S1 is repeated.

In step S2, the control unit 64 determines whether or not the restricted area determination unit 58 has detected that the predetermined restricted area 84 exists in the portion in front of the host vehicle 10 within the other lane 78. Moreover, as noted previously, the portion in front of the host vehicle 10 is a range, within the area in front of the host vehicle 10, in which the distance from the host vehicle 10 is less than or equal to the predetermined distance, or a range that the host vehicle 10 is capable of reaching within a predetermined time period. The predetermined distance can be set in accordance with the travel speed of the host vehicle 10. For example, the predetermined distance can be set to be longer as the travel speed of the host vehicle 10 increases. The predetermined time period can be set in accordance with the travel speed of the host vehicle 10. For example, the predetermined time period can be set to be longer as the travel speed of the host vehicle 10 increases. Consequently, in the case that the host vehicle 10 is traveling at a high speed, the presence or absence of the predetermined restricted area 84 can be detected in a range that extends to a distant place. In the case that the restricted area determination unit 58 has detected that the predetermined restricted area 84 exists in the portion in front of the host vehicle 10 within the other lane 78 (YES in step S2), the process transitions to step S3. In the case that the restricted area determination unit 58 does not detect that the predetermined restricted area 84 exists in the portion in front of the host vehicle 10 within the other lane 78 (NO in step S2), the process transitions to step S6.

In step S3, the control unit 64 determines whether or not the operation input detected in step S1 is an operation input for the purpose of making a lane change into the other lane 78 in which the predetermined restricted area 84 exists. In the case that the operation input detected in step S1 is an operation input for the purpose of making a lane change into the other lane 78 in which the predetermined restricted area 84 exists (YES in step S3), the process transitions to step S4. In the case that the operation input detected in step S1 is not an operation input for the purpose of making a lane change into the other lane 78 in which the predetermined restricted area 84 exists (NO in step S3), the process transitions to step S6.

In step S4, the control unit 64 determines whether or not the lane 78 into which the lane change is to be made is a lane 78 that leads to the destination. In the case that the lane 78 into which the lane change is to be made is a lane 78 that leads to the destination (YES in step S4), the process transitions to step S6. In the case that the lane 78 into which the lane change is to be made is not a lane 78 that leads to the destination (NO in step S4), the process transitions to step S5.

In step S5, the control unit 64 restricts the lane change. Stated otherwise, the control unit 64 does not execute the lane change. Upon completion of step S5, the process shown in FIG. 6 is brought to an end.

In step S6, the control unit 64 permits the lane change. Stated otherwise, the control unit 64 executes the lane change. Upon completion of step S6, the process shown in FIG. 6 is brought to an end.

In the foregoing manner, according to the present embodiment, in the case that the predetermined restricted area 84 exists in which continuous traveling of the host vehicle 10 in the other lane 78 is restricted in the portion in front of the host vehicle 10 within the other lane 78, the lane change is restricted. Therefore, according to the present embodiment, it is possible to provide the vehicle control device 12 in which a lane change can be suitably restricted.

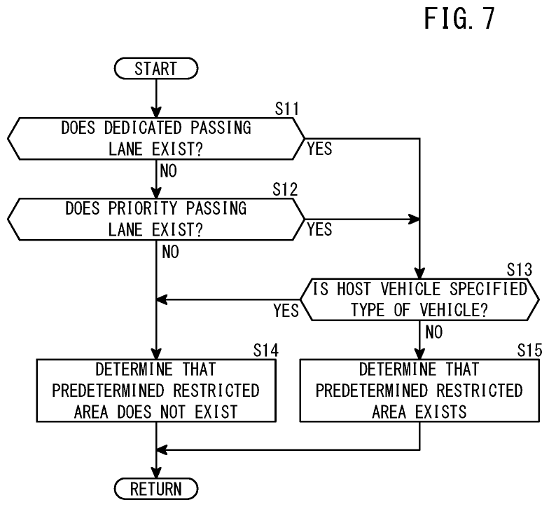

FIG. 7 is a flowchart illustrating an example of operations of the vehicle control device according to the present embodiment. In FIG. 7, details are shown of the process performed in step S2 described above.

In step S11, the restricted area determination unit 58 determines whether or not a dedicated passing lane through which a specified type of vehicle passes exists in the portion in front of the host vehicle 10 within the other lane 78. In the case that the dedicated passing lane through which a specified type of vehicle passes exists in the portion in front of the host vehicle 10 within the other lane 78 (YES in step S11), the process transitions to step S13. In the case that the dedicated passing lane through which a specified type of vehicle passes does not exist in the portion in front of the host vehicle 10 within the other lane 78 (NO in step S11), the process transitions to step S12.

In step S12, the restricted area determination unit 58 determines whether or not a priority passing lane in which passing of a specified type of vehicle is given priority exists in the portion in front of the host vehicle 10 within the other lane 78. In the case that the priority passing lane in which passing of a specified type of vehicle is given priority exists in the portion in front of the host vehicle 10 within the other lane 78 (YES in step S12), the process transitions to step S13. In the case that the priority passing lane in which passing of a specified type of vehicle is given priority does not exist in the portion in front of the host vehicle 10 within the other lane 78 (NO in step S12), the process transitions to step S14.

In step S13, the restricted area determination unit 58 determines whether or not the host vehicle 10 corresponds to the specified type of vehicle that is capable of passing through the dedicated lane, or alternatively, corresponds to the specified type of vehicle that is capable of passing preferentially through the priority lane. In the case that the host vehicle 10 corresponds to such a specified type of vehicle (YES in step S13), the process transitions to step S14. In the case that the host vehicle 10 does not correspond to such a specified type of vehicle (NO in step S13), the process transitions to step S15.

In step S14, the restricted area determination unit 58 determines that the predetermined restricted area 84 does not exist in the portion in front of the host vehicle 10 within the other lane 78.

In step S15, the restricted area determination unit 58 determines that the predetermined restricted area 84 exists in the portion in front of the host vehicle 10 within the other lane 78.

In this manner, in the case that the dedicated passing lane through which a specified type of vehicle passes exists in the portion in front of the host vehicle 10 within the other lane 78, and the host vehicle 10 does not correspond to the specified type of vehicle, the restricted area determination unit 58 may make a determination in the following manner. More specifically, in such a case, the restricted area determination unit 58 may determine that the predetermined restricted area 84 exists in the portion in front of the host vehicle 10 within the other lane 78. Further, in the case that the priority passing lane in which passing of a specified type of vehicle is given priority exists in the portion in front of the host vehicle 10 within the other lane 78, and the host vehicle 10 does not correspond to the specified type of vehicle, the restricted area determination unit 58 may make a determination in the following manner. More specifically, in such a case, the restricted area determination unit 58 may determine that the predetermined restricted area 84 exists in the portion in front of the host vehicle 10 within the other lane 78.

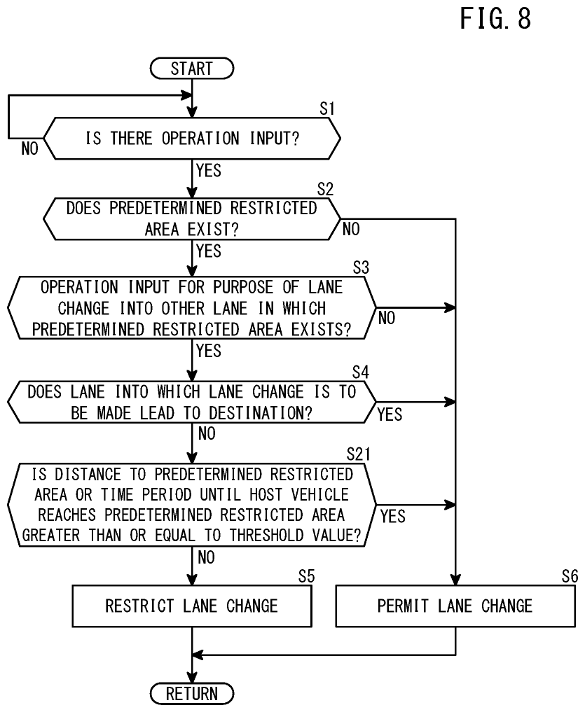

FIG. 8 is a flowchart showing an example of operations of the vehicle control device according to the present embodiment.

Steps S1 to S4 are the same as steps S1 to S4 described above with reference to FIG. 6, and therefore description of these steps is omitted. In the case that the lane 78 into which the lane change is to be made is not a lane 78 that leads to the destination (NO in step S4), the process transitions to step S21. In the case that the lane 78 into which the lane change is to be made is a lane 78 that leads to the destination (YES in step S4), the process transitions to step S6.

In step S21, the determination unit 62 determines whether or not a distance to the predetermined restricted area 84, or a time period until the host vehicle 10 reaches the predetermined restricted area 84 is greater than or equal to a threshold value. In the case that the distance to the predetermined restricted area 84, or the time period until the host vehicle 10 reaches the predetermined restricted area 84 is not greater than or equal to the threshold value (NO in step S21), the process transitions to step S5. In the case that the distance to the predetermined restricted area 84, or the time period until the host vehicle 10 reaches the predetermined restricted area 84 is greater than or equal to the threshold value (YES in step S21), the process transitions to step S6.

Steps S5 and S6 are the same as steps S5 and S6 described above with reference to FIG. 6, and therefore description of these steps is omitted.

In the foregoing manner, in the case that the distance to the predetermined restricted area 84, or the time period until the host vehicle 10 reaches the predetermined restricted area 84 is greater than or equal to the threshold value, the lane change may be permitted.

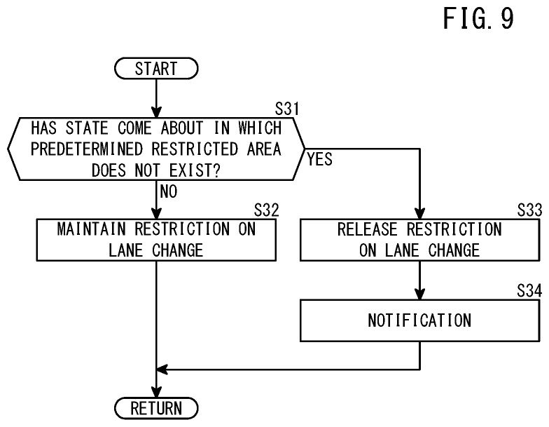

FIG. 9 is a flowchart showing an example of operations of the vehicle control device according to the present embodiment. The process shown in FIG. 9 can be performed when the restriction on the lane change (step S5) is being executed.

In step S31, the restricted area determination unit 58 determines whether or not a state has come about in which the predetermined restricted area 84 does not exist in the portion in front of the host vehicle 10 within the other lane 78. In the case that the predetermined restricted area 84 exists in the portion in front of the host vehicle 10 within the other lane 78 (NO in step S31), the process transitions to step S32. In the case that a state has come about in which the predetermined restricted area 84 does not exist in the portion in front of the host vehicle 10 within the other lane 78 (YES in step S31), the process transitions to step S33. Moreover, even in the case that a state has come about in which the predetermined restricted area 84 temporarily stops existing in the other lane 78, the restricted area determination unit 58 does not determine that a state has come about in which the predetermined restricted area 84 does not exist in the other lane 78 in the following cases. More specifically, in the case that the distance to another predetermined restricted area 84 in which traveling of the host vehicle 10 is restricted is less than or equal to the predetermined distance, a determination is not made that a state has come about in which the predetermined restricted area 84 does not exist in the other lane 78. Further, in the case that the time period until the host vehicle 10 reaches another predetermined restricted area 84 is less than or equal to the predetermined time period, a determination is not made that the predetermined restricted area 84 does not exist in the other lane 78.

In step S32, the control unit 64 maintains the restriction on the lane change. Upon completion of step S32, the process shown in FIG. 9 is brought to an end.

In step S33, the control unit 64 releases the restriction on the lane change. Upon completion of step S33, the process transitions to step S34.

In step S34, the notification unit 66 issues a predetermined notification to the user. The predetermined notification, as noted previously, is a notification for indicating that the restriction on the lane change has been released. Upon completion of step S34, the process shown in FIG. 9 is brought to an end.

In this manner, in the case that a state has come about in which the predetermined restricted area 84 does not exist in the portion in front of the host vehicle 10 within the other lane 78, the predetermined notification may be issued to the user.

Although preferred embodiments of the present invention have been described above, the present invention is not limited to the above-described embodiments, and various modifications can be made thereto without departing from the essence and gist of the present invention.

Summarizing the above-described embodiments, the characteristic features described below are realized.

The vehicle control device (12) comprises the restricted area determination unit (58) that determines whether or not, in the portion in front of the host vehicle (10) within the other lane (78) that differs from a host vehicle lane (78) in which the host vehicle is traveling, the predetermined restricted area (84) exists in which continuous traveling of the host vehicle in the other lane is restricted, and the control unit (64) that restricts the lane change of the host vehicle into the other lane in the case that the restricted area determination unit determines that the predetermined restricted area exists in the other lane. In accordance with such a configuration, in the case that the restricted area determination unit determines that the predetermined restricted area exists in which continuous traveling of the host vehicle in the other lane is restricted in the portion in front of the host vehicle within the other lane, the control unit restricts the lane change of the host vehicle into the other lane. Therefore, in accordance with such a configuration, it is possible to provide the vehicle control device in which a lane change can be suitably restricted.

In the case that the dedicated passing lane through which the specified type of vehicle passes, or the priority passing lane in which passing of the specified type of vehicle is given priority exists in the portion in front of the host vehicle within the other lane, and the host vehicle does not correspond to the specified type of vehicle, the restricted area determination unit may determine that the predetermined restricted area exists in the other lane. In accordance with such a configuration, it is possible to suitably determine whether or not the predetermined restricted area exists.

The restricted area determination unit may determine whether or not the predetermined restricted area exists in the other lane on the basis of the road signs (80) or the road markings (82). In accordance with such a configuration, it is possible to suitably determine whether or not the predetermined restricted area exists.

The above-described vehicle control device may further comprise the determination unit (62) that determines whether or not the distance to the predetermined restricted area, or the time period until the host vehicle reaches the predetermined restricted area is greater than or equal to a threshold value, wherein in the case that the determination unit determines that the distance to the predetermined restricted area, or the time period until the host vehicle reaches the predetermined restricted area is greater than or equal to the threshold value, the control unit may permit the lane change of the host vehicle into the other lane. In accordance with such a configuration, it is possible to prevent the lane change from being restricted, regardless of whether the distance to the predetermined restricted area is sufficiently large, or the time period until the vehicle reaches the predetermined restricted area is sufficiently long.

The above-described vehicle control device may further comprise the notification unit (66) that issues the predetermined notification to the user, in the case that a state in which the predetermined restricted area does not exist in the other lane has come about after the lane change of the host vehicle into the other lane is restricted. In accordance with such a configuration, the user can cause the host vehicle to travel in a suitable manner.

The above-described vehicle control device may further comprise the operation detection unit (60) that detects the operation input performed by the user, wherein the control unit may control the lane change on the basis of the operation input detected by the operation detection unit.

The restricted area determination unit may determine whether or not the predetermined restricted area exists in the other lane on the basis of the vehicle position information and the map information. In accordance with such a configuration, it is possible to reliably determine whether or not the predetermined restricted area exists.

The restricted area determination unit may determine whether or not the predetermined restricted area exists in the other lane on the basis of information obtained by the sensors (14) provided in the host vehicle. In accordance with such a configuration, it is possible to reliably determine whether or not the predetermined restricted area exists.

The vehicle (10) comprises the vehicle control device as described above.

The vehicle control method comprises the step (step S2) of determining whether or not, in the portion in front of the host vehicle within the other lane that differs from a host vehicle lane in which the host vehicle is traveling, the predetermined restricted area exists in which continuous traveling of the host vehicle in the other lane is restricted, and the step (step S5) of restricting the lane change of the host vehicle into the other lane in the case it is determined that the predetermined restricted area exists in the other lane, in the step of determining whether or not the predetermined restricted area exists.

What is claimed is:

1. A vehicle control device, comprising:
a restricted area determination unit configured to determine whether or not, in a portion in front of a host vehicle within another lane that differs from a host vehicle lane in which the host vehicle is traveling, a predetermined restricted area exists in which continuous traveling of the host vehicle in the other lane is restricted; and
a control unit configured to restrict a lane change of the host vehicle into the other lane in a case that the restricted area determination unit determines that the predetermined restricted area exists in the other lane.

2. The vehicle control device according to claim 1, wherein, in a case that a dedicated passing lane through which a specified type of vehicle passes, or a priority passing lane in which passing of the specified type of vehicle is given priority exists in the portion in front of the host vehicle within the other lane, and the host vehicle does not correspond to the specified type of vehicle, the restricted area determination unit determines that the predetermined restricted area exists in the other lane.

3. The vehicle control device according to claim 1, wherein the restricted area determination unit determines whether or not the predetermined restricted area exists in the other lane on a basis of a road sign or a road marking.

4. The vehicle control device according to claim 1, further comprising a determination unit configured to determine whether or not a distance to the predetermined restricted area, or a time period until the host vehicle reaches the predetermined restricted area is greater than or equal to a threshold value,
wherein, in a case that the determination unit determines that the distance to the predetermined restricted area, or the time period until the host vehicle reaches the predetermined restricted area is greater than or equal to the threshold value, the control unit permits the lane change of the host vehicle into the other lane.

5. The vehicle control device according to claim 1, further comprising a notification unit configured to issue a predetermined notification to a user, in a case that a state in which the predetermined restricted area does not exist in the other lane has come about after the lane change of the host vehicle into the other lane is restricted.

6. The vehicle control device according to claim 1, further comprising an operation detection unit configured to detect an operation input performed by a user,
wherein the control unit controls the lane change on a basis of the operation input detected by the operation detection unit.

7. The vehicle control device according to claim 1, wherein the restricted area determination unit determines whether or not the predetermined restricted area exists in the other lane on a basis of vehicle position information and map information.

8. The vehicle control device according to claim 1, wherein the restricted area determination unit determines whether or not the predetermined restricted area exists in the other lane on a basis of information obtained by a sensor provided in the host vehicle.

9. A vehicle comprising a vehicle control device, the vehicle control device comprising:
a restricted area determination unit configured to determine whether or not, in a portion in front of a host vehicle within another lane that differs from a host vehicle lane in which the host vehicle is traveling, a predetermined restricted area exists in which continuous traveling of the host vehicle in the other lane is restricted; and
a control unit configured to restrict a lane change of the host vehicle into the other lane in a case that the restricted area determination unit determines that the predetermined restricted area exists in the other lane.

10. A vehicle control method, comprising:
a step of determining whether or not, in a portion in front of a host vehicle within another lane that differs from a host vehicle lane in which the host vehicle is traveling, a predetermined restricted area exists in which continuous traveling of the host vehicle in the other lane is restricted; and
a step of restricting a lane change of the host vehicle into the other lane in a case it is determined that the predetermined restricted area exists in the other lane, in the step of determining whether or not the predetermined restricted area exists.
